(19) United States
(12) Patent Application Publication
(10) Pub. No.: US 2005/0057670 A1
(43) Pub. Date: Mar. 17, 2005

(54) Method and device for extracting and utilizing additional scene and image formation data for digital image and video processing

(76) Inventors: Damon L. Tull, Clarksville, MD (US); Aggelos K. Katsaggelos, Chicago, IL (US)

Correspondence Address: SCHIFF HARDIN LLP;Patent Department, 6600 Sears Tower, 233 South Wacker Drive, Chicago, IL, 60606, US

(21) Appl. No.: 10/824,138

(22) Filed: Apr. 14, 2004

Related U.S. Application Data
(60) Provisional application No. 60/462,388, filed on Apr. 14, 2003.
(60) Provisional application No. 60/468,262, filed on May 7, 2003.

(51) Int. Cl. H04N 5/228

(52) U.S. Cl. 348/241; 348/222.1

(57) ABSTRACT

A method and apparatus provides information for use in still image and video image processing, the information including scene and camera information and information obtained by sampling pixels or pixel regions during image formation. The information is referred to as meta-data. The meta-data regarding the camera and the scene is obtained by obtaining camera and sensor array parameters, generally prior to image acquisition. The meta-data obtained during the image formation obtained by sampling the pixels or pixel regions may include one or more masks marking regions of the image. The masks may identify blur in the image, under and/or overexposure in the image, and events occurring over the course of the image. Blur is detected by a sensing a change in pixel or pixel regions signal build up rate during the image acquisition. Under or over exposure is determined by pixels being below or above, respectively low and high thresholds. An event time mask is generated by sensing a sampling time during the image acquisition at which an event is sensed. Data on these masks is output with the image data for use in post image acquisition processing.

### CROSS-REFERENCE TO RELATED APPLICATIONS

The present application claims the benefit of U.S. Provisional Patent Application Ser. No. 60/462,388, filed Apr. 14, 2003, and U.S. Provisional Patent Application Ser. No. 60/468,262, filed May 7, 2003. The entire content of both provisional applications is incorporated herein by reference.

### BACKGROUND OF THE INVENTION

1. Field of the Invention

The present invention relates generally to a method and apparatus for the capture, analysis, and enhancement of digital images and digital image sequences and to a data format resulting therefrom.

2. Description of the Related Art

Millions of users are turning to digital devices for capturing and storing their documents and still and motion pictures. Market analysts estimate that more than 140 million digital image sensors were produced for digital cameras and scanners in all applications in 2002. This number is expected to grow over sixty percent per year through 2006. The digital image sensor is the “film” that captures the image and sets the foundations of image quality in a digital imaging system. Present camera designs require significant processing of the data from the digital image sensors in order to obtain a meaningful digital image from the “film” after the picture is taken. Despite this processing, millions of users are also being exposed to the need (and opportunity) to correct or adjust these images on computers using image manipulation software to obtain the desired image quality.

The body of algorithms, mathematics, and techniques, for the correction, adjustment, compression, transmission or interpretation of digital images and image sequences are prescribed by the broad field of digital image processing. Almost every digital imaging application incorporates some digital image processing algorithms into either the system software or hardware to achieve the desired objective. Most of these methods are used to process the image after the image has been acquired. Image processing methods that are used to process the image after the image formation are called post-processing methods. Post-processing methods make up the majority of techniques implemented in current imaging systems and include techniques for the enhancement, restoration and compression of digital image stills and image sequences.

Growing with millions who are essentially becoming their own photo-labs, by fixing, printing, and distributing their own digital images and video, is the demand for more a sophisticated means of post-processing images and video. Even film photographers are seeking solace in the digital domain to correct problems with their film images by scanning them in at kiosks to hopefully correct problems with the images using special post processing algorithms. Furthermore, the growth in digital imaging is leading to a burgeoning number of images and image sequences in digital format and the need to compress, describe catalogue, and transmit objects in digital still images and video is becoming paramount. This trend toward object or content based processing presents new opportunities as well as new challenges for the processing of digital still images and video.

The need to adjust picture quality after capture is required due to many factors. For example, lossy compression, inaccurate lens settings, inappropriate lighting conditions, erroneous exposure times, sensor limitations, uncertain scene structure and dynamics are all factors that affect final image quality. Sensor noise, motion blur, defocus, color aberrations, low contrast, and over/under exposure are all examples of distortions that may be introduced into the image during image formation. Lossy compression of the image further aggravates these distortions.

The field of image restoration is the area of digital image processing that provides rigorous mathematical methods for the estimation of an original, undistorted image from a degraded, observed image. Restoration methods are based on (parameterized) models of the image formation and the image distortion process. In contrast, the field of image enhancement provides methods for ad hoc, subjective adjustment of digital still images and video. Image enhancement methods are implemented without the guide of a rigorous image model. The overwhelming majority of software and hardware implementations of image processing algorithms utilize image enhancement methods because of their simplicity. However, because of their ad hoc application, image enhancement algorithms are effective on only a limited class of image distortions.

The need for improved image enhancement is demonstrated by the market driven efforts put forth by major digital imaging software companies like Adobe Systems Incorporated. Approximately $66 million of Adobe's reported $297 million in sales in the quarter ending Feb. 28, 2003, was spent on research and development in digital imaging software. Adobe also reported a 23% increase in digital imaging software sales over the same quarter of 2003. Among the most recent technical advances in this area is a new opportunity to access camera raw or the “digital negative” image for more powerful post-processing. The “digital negative” is the image data before post processing closest to the sensor array. However, post-processing of even the raw camera data remains limited if information regarding the scene and the camera is not incorporated into the post-processing effort.

Many digital image distortions are caused by the physical limitations of practical cameras. These limitations begin with the passive image formation process used in many digital imaging systems. Traditional imaging systems, as shown in FIG. 1a, accomplish image formation by focusing light 20 (or some desired energy distribution at specified wavelengths) on an array of light (or energy) sensitive sensor pixels 22 using a lens system 24. Shuttering, by an electronic or mechanical shutter apparatus 26, controls the amount of light observed by the film/sensor array 22. The time over which the shutter 26 allows light to be observed by the array 22 is known as the exposure time. During the exposure time, the sensor array/film elements 22a sense the photo-electronic charge/current generated by the light 20 incident on each pixel region. It is assumed that the exposure time be set to prevent saturation of the pixels 22a in bright light. This process can be expressed by the equation,

$$\tilde{f} ( \underline{l} ) ∝ {\int }_{0}^{{τ}_{e}} {\int }_{\underline{l} - \underline{ɛ}}^{\underline{l} + \underline{ɛ}} ( {i}_{ph} ( \underline{l} , t ) + {i}_{n} ( \underline{l} , t ) ) ⅆ \underline{l} ⅆ t$$

where, \check{f}(l) is the continuous value of image intensity (before analog-to-digital conversion) at pixel location l=(x,y), τₑ is the exposure time in seconds, ε=(εₓ, ε_{y}) is the pitch of the pixel respectively, iₚₕ(l,t) and iₙ(l,t) are the photo electronic current and electronic noise current at location l at time t.

The equation describes the pixel level image formation found in almost all digital and chemical film imaging systems. The equation also describes the image formation as a passive, continuous time process that requires shutter management and exposure time determination. Shutter management and exposure time determination is one of the weaknesses of conventional image formation and is based on a one hundred year old film image capture philosophy. This is the same image formation approach that provided the original motivation to digitize film photographs for post processing in the 1960's.

Shuttering is used to prevent bright light from saturating chemical film and to limit bleaching and blooming in electronic imaging arrays. In shuttering, the entire film/array surface is subject the same exposure time despite the fact that the brightness of the incident light varies across the area of the film. For this reason, some areas on the film are often underexposed or overexposed because of the global determination of exposure time. In addition, most exposure time determination strategies are easily tricked by scene dynamics, lens settings and changing lighting conditions. The global shuttering approach to image formation is only suitable for capturing static, low contrast images where the scene and camera is stationary and the difference between bright and dark regions in the image is small.

For these and other reasons presented later herein, the performance of the current digital and film cameras are limited by design. The passive image formation process described in the equation limits low light imaging performance, limits array (or film) sensitivity, limits array (or film) dynamic range, limits image brightness and clarity, and allows for a host of distortions including noise, blur, and low contrast to corrupt the final image.

Whether in a digital or chemical film imaging system, the sensor array 22 sets the foundation of image quality. How this image is captured is key because the quality of the signal read from the “film” guides the ultimate image quality downstream. The image formation process as shown in FIG. 1b includes the steps of: opening the shutter and starting the image formation 30; waiting for the image to form 32; closing the shutter 34; capturing the image by reading it from the sensor 36; processing the image 38; compressing the image 40; and storing the image 42. This process impedes the performance of post-processing of images from diagnostic imaging systems, photography, mobile/wireless and consumer imaging, biometrics, surveillance, and military imaging. The limitations and corresponding engineering trade offs are reduced or eliminated with the invention described herein.

The earliest post-processing algorithms were developed to correct the distortions observed in moon images caused by the inherent limitations of the television camera aboard the Ranger 7 probe launched in 1964. Almost 40 years later, post-processing algorithms remain necessary to correct image distortions from cameras. The major obstacle to accurate and reliable post-processing of digital images and video is the lack of detailed knowledge of the imaging system, the image distortion, and the image formation process. Without this information, adjusting the image quality after the image formation is an inefficient guessing game. Many post-processing software packages, for example, Adobe Photoshop and Corel Paint, give the user some control over their image enhancement algorithms. However, without detailed knowledge of the image formation process, the suite of image improvement tools in these packages: cannot correct the underlying source of the distortion; are limited to user selectable or global algorithm implementation; are not compatible with object oriented post-processing; are useful on a limited class of image distortions; are often applied in image regions that are not distorted; are not suitable for reliable automatic removal of many distortions; and are applied after the image formation process is complete.

The most successful applications of post-processing for image enhancement are those where one or more of the following is known: knowledge of the scene, knowledge of the distortion, or knowledge of the system used to acquire the image. An example of a startling success in post-processing is the Hubble Space Telescope (HST). The images from the billion dollar HST were distorted due to a misaligned mirror. The behavior of the HST was well known and highly engineered, therefore it was possible to derive accurate image distortion models that could be used to restore the degraded HST images. The HST mirror was later fixed in a another mission; however, due to the available technology, many distorted images where salvaged by post processing.

Unfortunately most post-processing software and hardware implementations do not have access to nor do they incorporate or convey limited knowledge of the scene, the distortion, or the camera in their processing. In addition, the parameters that characterize the filters and algorithms used to reliably remove distortions from digital images and video require additional knowledge that is often lost after the image is formed and stored.

Detailed information is required to properly (and automatically) adjust image quality. The beginnings of such information includes, for example, camera settings (aperture, f-stop, focal length, exposure time) and film/sensor array parameters (speed, color filter array type, pixel size and pitch), are examples of some of the parameters available for exchange according to the digital camera standard EXIF V2.2. However, these parameters only describe the camera parameters not the scene structure or dynamics. Detailed scene information is not extracted or conveyed to the end user (external devices) in conventional cameras. Meta-data regarding the scene structure and dynamics is extremely valuable to those who want to restore images, correct severe distortions, or analyze complex digital images quickly.

In general, post processing becomes inefficient in the absence of such knowledge in that the perceived distortion may not be in the user selected region of the image. In this case, post-processing is applied in areas where no distortions exist, resulting in wasted computational effort and the possibility of introducing unwanted artifacts.

Despite the definition of sophisticated content or object based encoding standards for digital still images and digital video images, there remains the challenge of breaking down the image into its component objects. This process is called image segmentation. Efficient and reliable image segmentation remains an open challenge. In order for the higher level content-based functionality of multimedia standards, such as MPEG-4 and MPEG-7 to expand in popularity, segmenting the image (sequence) into its components and providing a framework for post processing these objects will be required.

A powerful cue for image segmentation is motion. The evidence and nature of the motion in an image sequence provides salient cues for differentiating background objects from foreground objects. Important information regarding the motion of objects in a still image is lost during image formation. If an object moves during image formation, a blur will be evident in the final image. Characterizing the blur in the image requires more information than what is available in a single frame. However, sufficient information regarding the motion and the extent of a moving object can be derived by monitoring the behavior of pixels during image formation.

### SUMMARY OF THE INVENTION

The present invention extracts, records, and provides critical scene and image formation data, referred to herein as meta-data, to improve the effectiveness and performance of still image and video image processing using hardware and software resources. Without a loss of generality, from this point forward, post-processing will refer to hardware and software apparatus and methods for both digital still image and video image processing. Digital still image and video image processing includes methods for the enhancement, restoration, manipulation, automatic interpretation and compression of visual communications data.

Many image distortions can be detected and, in some cases, prevented at the pixel level during image formation. Post-processing can be used reduce or eliminate these distortions without pixel level processing if sufficient information is provided to the post-processing algorithms. Part of the present invention is the definition of the relevant information required for post-processing to efficiently remove difficult distortions.

Key innovations of the various embodiments of this invention are to improve image and video post-processing through: extraction of meta-data from the image both at and during the image formation process; computation and provision of meta-data describing the type and presence of a distortion or activity in an image or image sequence region; computation and provision of meta-data to focus processing effort on specific regions of interest within an image or image sequence; and/or to provide sufficient meta-data for the correction of an image or image sequence region based on the type and extent of the distortion of digital images and video.

The invention disclosed in this document in its various embodiments can be: used in any array of sensors where the all or part of the array elements are used to extract an image or some other interpretable information; used in multi-dimensional imaging systems including 3D and 4D imaging systems; applied to arrays of sensors that are sensitive to thermal or mechanical, or electromagnetic energies; applied to a sequence of images to derive a high quality individual frame; and/or implemented in hardware or software.

### BRIEF DESCRIPTION OF THE DRAWINGS

FIG. 1a is a schematic diagram of a generic conventional digital imaging system;

FIG. 1b is a flow diagram of the process steps being carried out by the imaging system of FIG. 1a;

FIGS. 2a, 2b, 2c and 2d are graphs of pixel charge accumulation;

FIGS. 3a, 3b, 3c and 3d are graphs of pixel signal intensity;

FIG. 4 is a functional block diagram of an intra-acqusition meta-data (I-Data) extraction process;

FIG. 5 is a block diagram of the functional steps of the distortion detector;

FIG. 6 is a 4×4 blur mask which corresponds to a 4×4 group of pixels or a 4N×4M region of an image where N×M is the size of image blocks over which the measurement was taken for each blur mask element;

FIG. 7 is a 4×4 intensity mask which corresponds to a 4×4 group of pixels or a 4N×4M region of an image where N×M is the size of image blocks over which the measurement was taken for each blur mask element.

FIG. 8 is a 4×4 time event mask which corresponds to a 4×4 group of pixels or a 4N×4M region of an image where N×M is the size of image blocks over which the measurement was taken for each time event mask element and N is the maximum number of samples taken during image formation;

FIG. 9a is a block diagram showing a basic digital camera OEM development system architecture;

FIG. 9b is a block diagram of a basic digital camera with a meta-data processor;

FIG. 10a is a schematic diagram showing a meta-data enabled image formation;

FIG. 10b is a flow diagram showing a meta-data enabled image formation of FIG. 10a;

FIG. 11a is a block diagram of a meta-data processor implementations having the meta-data processor combined with system controller;

FIG. 11b is a block diagram of a meta-data processor implementation having the meta-data processor combine with DSP/RISC processor

FIG. 11c is a block diagram of a meta-data processor implementation having the meta-data processing combined with system controller and DSP/RISC; and

FIG. 12 is a diagram of a sample data structure for I and P meta-data for use by either an internal DSP/RISC processor or external post-processing software.

### DETAILED DESCRIPTION OF THE PREFERRED EMBODIMENTS

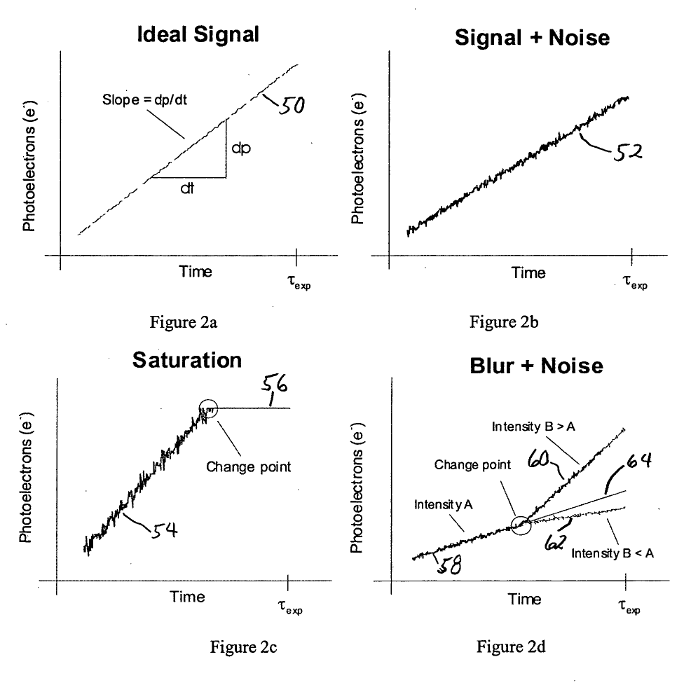

In an embodiment of the present invention, information regarding the scene is derived from analyzing (i.e. filtering and processing) the evolution of pixels (or pixel regions) during image formation. This methodology is possible since many common image distortions have pixel level profiles that deviate from the ideal. Pixel profiles provide valuable information that is inaccessible in conventional (passive) image formation. Pixel signal profiles are shown in FIGS. 2a, 2b, 2c and 2d to illustrate common image and video distortions that occur during image formation. Ideally, during image formation the photoelectric charge should linearly increase to a final value within the dynamic range of the sensor pixel, as shown in FIG. 2a. The final pixel intensity is proportional to integral under this curve. In particular, the charge accumulation 50 is shown as an increase in photoelectrons (the vertical axis) over the exposure time (the horizontal axis). In the case of a noisy image as illustrated in FIG. 2b, the noise adds a random component to the rate of increase of the charge in the pixel, at 52. In a case of saturation of the pixel as shown in FIG. 2c, the photoelectric charge builds up at 54 during image formation until it reaches a maximum level 56 of the pixel dynamic range, after which it levels off. In the case of blur in the image, such as could be caused by motion of an object in the image frame, the photoelectric charge profile 58 is interrupted by a change in intensity which can increase 60 or decrease 62 the rate of photo charge from the path 64 the photocharge would otherwise take, as shown in FIG. 2d. In the illustration of the blur in FIG. 2d, the interruption is a non-linearity, or change in slope, of the charge signal. Deviations from the ideal profiles 64 are easily detected by monitoring the image formation process at each pixel and implementing change detection and prediction algorithms to detect each case. Pixel level profiles provide temporal information regarding the image formation process.

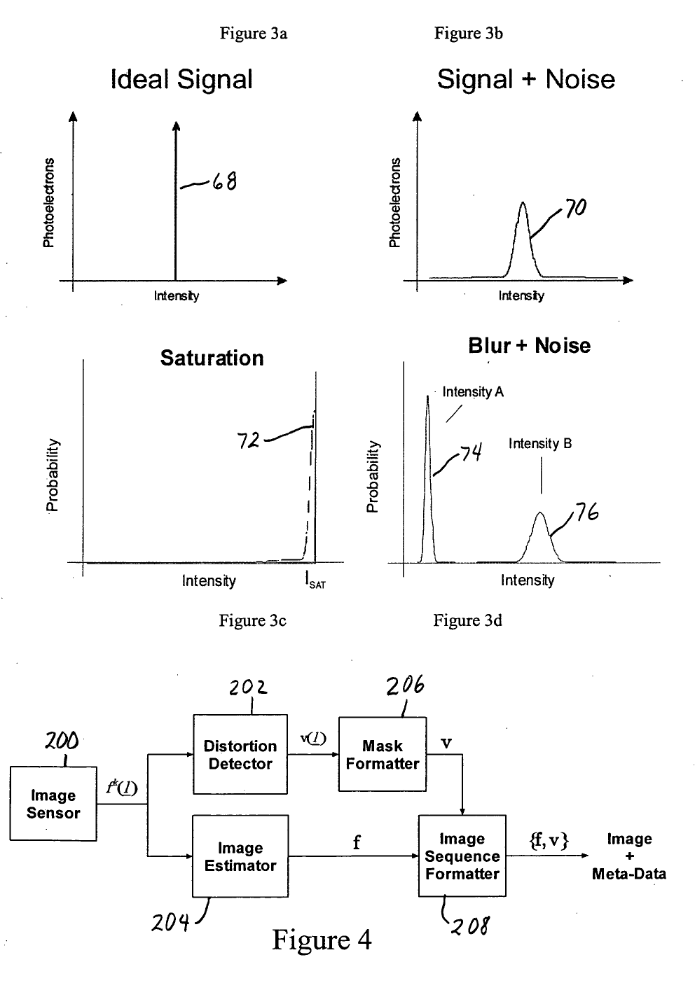

Signal distributions shown in FIGS. 3a, 3b, 3c and 3d illustrate the distributions of common image and video distortions that may occur during image formation. The graphs here show intensity along the horizontal axis and photoelectric charge along the vertical axis. Ideally during the image formation, the distribution of a sampling of the pixel should give a single value 68 for the distribution as shown FIG. 3a. In the case of a noisy image, FIG. 3b, the noise component creates a spread of pixel values around the original intensity value as shown by the curve 70. In the curve 70, the photoelectron charge peaks at the intensity of the previous signal but does not reach the same value and is spread over a wider range, including a low level of charges scattered over a wide range of intensity values. As shown in FIG. 3c, in the case of saturation of the pixel during the formation of the image, the distribution contains small amounts of probability mass at values near the edge of the dynamic range leading up to the saturation point I_{SAT}. The majority of the probability mass 72 is contained in the maximum value of the pixel dynamic range. In the case of blur and noise as illustrated in FIG. 3d, a multi-modal or multi-peak distribution 74 and 76, for example, is the resulting intensity distribution. Detection of deviant distributions from the ideal distribution provide a rigorous basis for the simultaneous estimation of intensities as well as change points during image formation.

The graphs of FIGS. 2a-2d and 3a-3d show that an important class of image distortions are easily identified using pixel level profiles and distributions. This information is hidden in conventional image formation. The resulting distortions are difficult (if not impossible) to identify and remove after the image formation processing is complete without side information. The definition, computation, and use of side information or meta-data for better post-processing are a focus of the present invention.

In an embodiment of the invention, meta-data refers to a set of information that can be used to improve the performance or add new functionality to the post-processing of digital images and video in either software or hardware. Meta-data may include one or more of the following: camera parameters, sensor/film parameters, scene parameters, algorithm parameters, pixel values, time instants or distortion indicator flags. This list is not exhaustive, and further aspects of the image may be identified in the meta-data. The meta-data in various embodiments conveys information regarding single pixels or arbitrarily shaped or sized regions, such as object regions.

Using this definition, meta-data can be put into one of two categories, (1) pre-acquisition meta-data (P-Data) and (2) intra-acquisition meta-data (I-Data). Pre-acquisition meta-data refers to the scene and imaging system information available before image is formed on the sensor array. The P-Data may vary from image to image but is static during image formation. Such pre-acquisition data can also apply to film systems. P-Data data is derived by the imaging system before acquiring an image of the desired light (energy). Specific examples of pre-acquisition meta-data can includes all of the tags in the EXIF standard, for example, exposure time, speed, f-stop, and aperture size.

Some of this information is available far in advance of the image acquisition, such as the sensor parameters and lens focal length. Other information is available only immediately before the image acquisition begins, such as ambient light conditions and exposure time. The present invention also encompasses meta-data within the class of pre-acquisition meta-data that is captured and defined during the image capture, or acquisition. For instance, exposure time could be set by the imaging system prior to initiating the image acquisition or may be changed during the course of image acquisition as a result of changes in the lighting conditions, for example, or due to real time monitoring of the image capture by light sensors or the like. This information is included within the definition of pre-acquisition meta-data for purposes of this invention even if some of the data is derived during the acquisition of the image.

The determination of the pre-acquisition parameters facilitates the attainment of meaningful images. Many image distortions occur and cannot be addressed in subsequent processing when these parameters are improperly set or are unknown. With such information available, processing of the image can be carried out in a meaningful way.

Intra-acquisition meta-data, or I-Data, refers to the information regarding the image that can be derived during the image formation process. The I-Data tends to be dynamic information that provides data that can be used to detect the onset or presence of an image distortion in a specific pixel or region of pixels. The intra-acquisition data is, in one embodiment of the invention, derived on a pixel or pixel region basis by monitoring the pixels or pixel regions, although it is within the scope of this invention that the intra-acquisition data could be image wide. I-Data conveys information for image post-processing software or hardware to correct or, in some cases, prevent distortions from corrupting the details of the final image. Those skilled in the art also will note that I-Data can assist in motion estimation and analysis and image segmentation. I-Data can include but is not limited to, distortion indicator flags and time instants for a pixel or group of pixels. An efficient representation for I-Data according to the present embodiment is as masks where each pixel or pixel block location is mapped to a specific I-Data location. For example, in an image sized mask, each pixel can map to specific I-Data mask location.

The present method addresses both the rate of accumulation of the signal intensity and changes in the rate of signal accumulation or signal intensity at the sensor, pixel or pixel region that occur at or after a time of acquisition of the image. These may be a result of, for example, movement that occurs by one or more objects in the image frame or by the image capture device during the acquisition, unexpected time variations in illumination or reflectance, or under-exposure (low light) or over-exposure (saturation) of the sensors, pixels or pixel regions during the acquisition of the image. The events which are characterized as changes in the rate of signal accumulation may be described as temporal events or temporal changes in the image during the acquisition since they occur at some time or over some time during the image acquisition interval. They may also be thought of as temporal perturbations or unexpected temporal changes. Motion is one class of such temporal change. The rate of change of the intensity signal is used to identify and correct the temporal events, and can also be used to identify and correct low light conditions wherein insufficient light reaches the sensor to overcome the effects of noise on the desired signal.

In one embodiment, the intra-acquisition meta-data extraction process utilizes an image sensor 200, distortion detector 202, image estimator 204, mask formatter 206, and an image sequence formatter 208, as shown in FIG. 4.

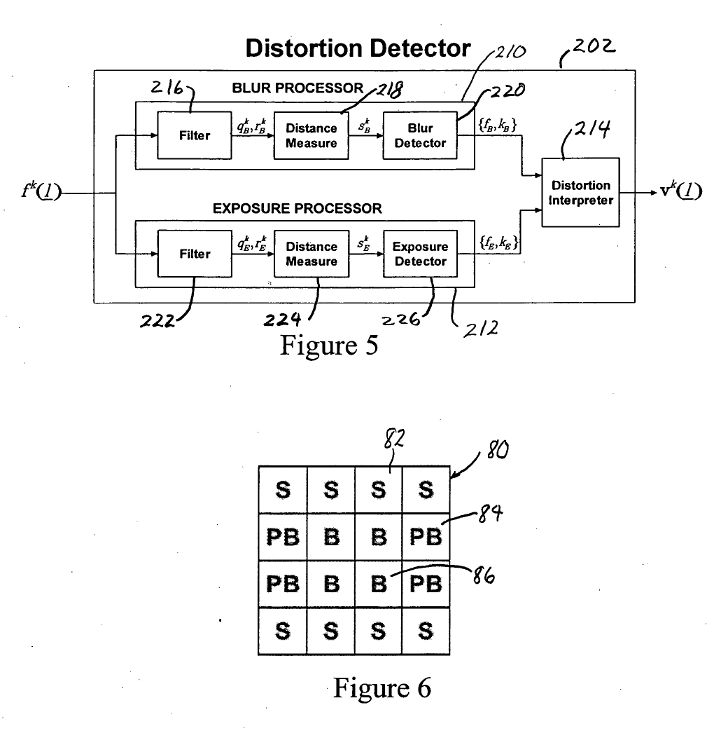

In further detail as shown in FIG. 5, the preferred distortion detector 202 includes a blur processor 210 and an exposure processor 212, the outputs of which are connected to a distortion interpreter 214. Within the blur processor 210 is a filter 216, a distance measure 218 and a blur detector 220. Within the exposure processor 212 is a filter 222, a distance measure 224 and an exposure detector 226.

In FIG. 5, f^{k}(l), the k^{th} sample of the image intensity at location l in the senor array is sent to a blur processor and exposure processor module. In the blur processor, the signal is filtered to obtain signal estimate \hat{q}_{B}^{k} and error residual r_{B}^{k}. The signal estimate and error residual is sent to the distance measure module which generates the input to the blur detectors s_{B}^{k}. This flexible architecture allows a number of filtering and distance measures to be used. Filtering techniques including the broad scope of finite impulse response (FIR), infinite impulse response (IIR) and state space filters (i.e., Kalman filters) can be used to obtain \hat{q}_{B}^{k} and r_{B}^{k}. In this embodiment, for simplicity, a sliding window FIR filter whose coefficients are designed to minimize the least squares distance between \hat{q}_{B}^{k} and f^{k}(l) is used in the filter block of the blur processor. The residual is computed as r_{B}^{k}=f^{k}(l)−\hat{q}_{B}^{k}.

The distance measure module in the blur processor determines what facet of the signal will be detected to indicate a distortion. Motion blur distortions occur when individual pixels in an image region observe a mixture of multiple intensities caused by moving objects during image formation. Detecting motion blur at the pixel level, is to detect the change in image intensity at the pixel during image formation. By detecting this change, the original (pre-blur) pixel intensity can be preserved. The distance measure may used to detect a change in the mean, variance, correlation or sign of correlation of the residual r_{B}^{k}. Since the pixel in an imaging array experience both signal dependent (i.e., shot noise) and signal independent noise (i.e., thermal noise) change in mean, variance and correlation can be applied. In this embodiment, the change in mean distance measure, s_{B}^{k}=r_{B}^{k} is used. Examples of change in variance, correlation or sign of correlation distance measures include s_{B}^{k}=(r_{B}^{k})²−sᵣ², s_{B}^{k}=r_{B}^{k}f^{k-m}(l) and s_{B}^{k}=sign(r_{B}^{k}r_{B}^{k-1})respectively where sᵣ² is a known residual variance and m<k.

When a distortion is detected, the blur detection module emits an alarm consisting of the time of the distortion k_{B}, and a (pre-distortion) pixel value f_{B}. The blur detection algorithm in the change of mean case uses the CUSUM (Cumulative SUM) algorithm,

$${g}_{B}^{k} = \{ \begin{matrix}max ( {g}_{B}^{k - 1} + {s}_{B}^{k} - v , 0 ) & {g}_{B}^{k - 1} \leq {h}^{k} \\ 0 & otherwise\end{matrix} .$$

where n>0 is a drift parameter and h^{k}>0 is an index dependent detection threshold parameter. This algorithm is resistant to false positives caused by large instantaneous errors below threshold h^{k} thus permitting integration or filtering of the pixel intensity to continue. The drift parameter adds a temporal low-pass filtering that effectively filters or “subtracts-off” spurious errors, reduces false positives, and making the detection process biased to large localized errors or small clustered errors characterized by motion blur. When g_{B}^{k} exceeds the threshold h^{k}, an alarm is emitted and the algorithm is restarted g_{B}^{k}=0 in the next time instant. The threshold h^{k} is allowed to be index dependent to maximize integration time at each pixel. The threshold h^{k} is ignored at first sample time k=1, and may be allowed to increase at the end of the exposure interval since the larger intensity deviations will be required to corrupt a pixel near the end of exposure time. This is allowed to further reduce signal independent noise at the pixel. The essential tradeoff in change detection is sensitivity versus delay. The values h^{k} and n are tuned to optimize detection time and to prevent false positives, those skilled in the art are familiar with methods to design these parameters. The disclosed method of blur detection is superior to the work first by Tull and later by El-Gamal by allowing forgetting into the detection process and by allowing for meta-data to be generated from the detection process.

The magnitude processor 212 shown in FIG. 5 including a filter stage 222, a distance measure module 224 and a exposure detector module 226 that determines if a pixel is properly exposed. This determination is based on the slope and value of the evolving pixel intensity. If the slope and value of a pixel is below a lower threshold, the pixel is said to be under-exposed relative to the noise sources at the pixel. If the slope and value of a pixel exceeds a maximum limit relative to its dynamic range, this pixel is said to be over-exposed. In this embodiment, the lower threshold, h_{L}, is a constant for the entire image determined by the dark current density (specified by the manufacturer) of the sensor element and the analog-to-digital conversion (ADC) noise or both. In this case, the evolving slope and value of the pixel is used to predict its final value. If this final value is below a specified signal-to-noise ratio, the pixel is flagged as under-exposed. The upper threshold, h_{U}, is a constant for the entire image determined by the well capacity (or saturation current) specified by the manufacturer of the sensor array this also corresponds to the maximum bit depth of the ADC after analog to digital conversion. As the intensity of the pixel reaches this upper threshold limit, the pixel loses light sensitivity.

In the filter stage of the exposure processor, an estimate of the current image intensity \hat{q}_{E}^{k} is obtained using a 2^{nd} order auto-regressive (AR) prediction error estimator¹, which gives the prediction error, r_{B}^{k}=f^{k}(l)−\hat{q}_{B}^{k}.

The output of the exposure processor distance measure module is computed from s_{E}^{k}=\hat{q}_{E}^{k}+(N−k)r_{B}^{k} which is an extrapolation of the current intensity estimate to its final pixel intensity.

The exposure detector module implements two CUSUM based algorithms,

$${g}_{L}^{k} = \{ \begin{matrix}max ( {g}_{L}^{k - 1} + {s}_{E}^{k} - {v}_{L} , 0 ) & {g}_{L}^{k - 1} \leq {h}_{L} \\ 0 & otherwise\end{matrix} \\ and , \\ {g}_{U}^{k} = \{ \begin{matrix}max ( {g}_{U}^{k - 1} + {s}_{E}^{k} - {v}_{U} , 0 ) & {g}_{U}^{k - 1} \leq {h}_{U} \\ 0 & otherwise\end{matrix}$$

where h_{L} and h_{U} are the lower and upper detector thresholds, n_{L} and n_{U} the lower and upper drift coefficients and g_{L}^{k} and g_{U}^{k} are the upper and lower test statistics, respectively. The drift coefficients and threshold are set to perform upper and lower boundary detection for the pixel intensity. When either test statistics exceed their respective thresholds, an alarm consisting of the instantaneous prediction error, stored in f_{E}, and the time instant of the alarm, k_{E}, is sent to the distortion interpreter.

The distortion interpreter (DI) 214 prioritizes the distortion vectors and prepares the intra-acquisition meta-data for each pixel. The interpreter tracks changes in the distortion vectors and eliminates redundant detection. In the embodiment, the interpreter is responsible for recording one distortion event (per pixel per exposure) to minimize storage. A multiplicity of distortion events per pixel per exposure time can be catalogued with sufficient memory resources. The distortion interpreter generates, stores and emits meta-data based on events obtained from the exposure and blur detectors. The meta-data output vector format for each pixel is
v(l)={(distortion class, time, value),(distortion class, time, value)}

Each pixel can only have a single exposure class distortion or a single blur class distortion or both. Two single or blue class distortions are not allowed. For example, let a pixel experience a single change corresponding to motion at instant k during the exposure time. At the end of the exposure time, the DI generates a vector, v(l)={PB,k,f_{B}}, where PB is a distortion class symbol indicates partially blurred, k is the time instant and f_{B} is the pre-distortion value of the pixel. This vector allows the fully exposed value of the original pixel intensity to be reconstructed in post-processing as, f^{N} (l)=(N/k)×f_{B} where N is the number of observations made during image formation. Consider the same pixel but the new intensity value observed by this pixel will saturate the pixel. In this case the meta-data vector becomes, v(l)={PB,k,f_{B},X,k+1,f_{E}}. This vector allows post processing software to accurately reconstruct the original un-blurred pixel at time k and the high intensity pixel value observed at instant k+1. The pixel value at k+1 is given as f^{k+1}(l)=(N/k+1)×f_{E}. If the pixel is reset at this point, more intensities could be estimated. By predicting the onset of saturation, light intensities N times brighter than the dynamic range of the pixel can be represented in post-processing, where N is the number of observations of the pixel.

The distortion interpreter generates one of three blur distortion class symbols per pixel, partially-blurred (PB), blurred (B), or no blur at all (S). The S class is typically dropped in practice. This classification is based on the number of changes observed during image formation. In the case of a PB pixel, a single change is observed during image formation as is the case when an object covers or uncovers a pixel (or pixel region). When two or more intensity changes are observed during image formation the pixel is said to be blurred (B) pixel. When no changes are detected during image formation then the pixel is a stationary or an (S) pixel. In practice (PB and B) pixels do not occur in isolation. The distortion interpreter enforces this constraint on the Blur Processor detector by checking neighborhood pixels for other (PB and B) pixels to ensure consistency. The distortion interpreter may reset the condition of the blur processor to enforce this condition at a local pixel.

The distortion interpreter also generates one of three exposure distortion class symbols per pixel, under-exposed (L), over-exposed (X) or sufficiently exposed (N). In practice (L and X) pixels do not occur in isolation. The distortion interpreter enforces this constraint on the exposure processor by checking neighborhood pixels for other (L and X) pixels to ensure consistency. The distortion interpreter may reset the condition of the exposure processor to enforce this condition. The (L) assignment will allow the noise in under-exposed pixels to be spatially filtered with similar pixels in post-processing. Numerous methods to filter noise are known to those skilled in the art.

The image intensity estimator develops the final value of the image from the samples, f^{k}(l) and produces a two dimensional vector of intensity values f. Various filtering methods can be used to estimate the final image intensity to reduce noise. In this embodiment, the image intensity is accumulated (and later averaged) as in a conventional imaging system while distortions are managed by the distortion detector.

The mask formatter structures the intra-acquisition meta-data into masks for efficient storage and transmission for each pixel. The intra-acquisition meta-data may be provided for pixel groups rather than for individual pixels in some instances. The groups or regions of pixels may be defined in any number of ways. In one embodiment, the regions of pixels are defined by binning of the pixels during imaging. Binning is the process whereby groups of adjacent pixels are combined to act as a single pixel during the image capture.

For purposes of the present invention, the terms pixel and pixel regions include sensors having multiple sensor elements, sensor elements arranged in a sensor array, single or multiple chip sensors, binned pixels or individual pixels, groupings of neighboring pixels, arrangements of sensor components, scanners, progressively exposed linear arrays, etc. The sensor or sensor array is more commonly sensitive to visible light, but the present invention encompasses sensors that detect other wavelengths of energy, including infrared sensors (such as near and/or far infrared sensors), ultraviolet sensors, radar sensors, X-ray sensors, T-ray (Terahertz radiation) sensors, etc.

The present invention refers to masks for defining various regions and/or groups of pixels or sensors. The identification of such groups of sensor or regions need not be described by a mask in the traditional sense of image processing, but for purposes of the present invention encompasses identification and/or definition of the sensors, pixels, or regions by whatever means provides a communication of the identified sensors, pixels or regions. References to masks herein include such definitions or identifications.

A blur mask is provided according to some embodiments of the invention. In a still image, motion blur is both a objectionable image distortion as well as an important visual cue. There is psychophysical evidence from the visual science literature that motion related distortions are used by the human visual system to adjust the perceived spatial and temporal resolution of the images on the retina. For this reason, appropriate treatment of the blur in the image is important to the visual clues for the observer or for removing undesired blur. The blur mask is therefore an important meta-data component in some embodiments of the invention. The purpose of the blur mask is threefold: to define regions corresponding to fast moving objects, to facilitate object oriented post-processing, and to remove motion related distortions.

FIG. 6 illustrates a 4×4 blur mask 80 which may correspond to a 4×4 group of pixels or a 4N×4M region of an image, where N×M is the size of image blocks over which the measurement is taken for each blur mask element. This mask indicates which pixels or pixel regions in an image have experienced blur during the image formation process. Motion blur occurs when a pixel or pixel region under goes a change such that multiple intensities are received during image acquisition. Motion blur is detected by monitoring the pixel or pixel region intensities during image formation. When the evolution of the intensity in a pixel or pixel region deviates from an expected trajectory, a blur is suspected to have occurred.

Each element of the blur mask 80 can classify a pixel in one of three categories, as noted in FIG. 6:

Category S—Stationary: A pixel is assigned this designation if it has been determined that the pixel observed a single energy intensity during image formation and therefore did not experience a motion related blur. This determination can be made deterministically or stochastically. An example of a stationary pixel or pixel group is indicated in FIG. 6 at 82.

Category PB—Partially blurred: A sensor pixel is assigned this designation if it has been determined that, at any instant, the sensor pixel observed a mixture of two more distinguishable energy intensities during the image formation time, or exposure time. In this case, the sensor pixel contains a blurred observation of the original scene. When used in conjunction with pixel motion estimates and the classification B—Blurred, the PB—partially blurred classification specifically designates pixels that observed a combination of moving and stationary objects. In the usual case, the moving objects are foreground objects and the stationary objects are background objects, although this is not always so. An example of a partially blurred pixel or pixel group is indicated in FIG. 6 at 84.

Category B—Blurred: A pixel is assigned this designation if it has been determined that the pixel or pixel region observed a mixture of multiple energy intensities throughout the image formation time and therefore the pixel is a blurred observation of the original scene. An example of a blurred pixel or pixel region is indicated in FIG. 6 at 86.

When used in conjunction with pixel motion estimates and the PB—partially blurred pixel classification, the B—blurred pixel classification specifically designates pixels or pixel regions that only observed moving, usually foreground, objects during the exposure time. The reference to objects here and throughout is not limited to physical objects, but includes image areas that may include background, foreground or mid-ground objects or areas or portions of objects.

The classification process for each pixel or pixel region can be made deterministically (such as by detecting changes in slope of the pixel profile), or stochastically (such as by using estimation theory and detecting changes in an estimated parameter vector) using a single pixel or pixel region or by using multiple pixels or pixel regions in each case. In the absence of pixel or pixel region motion estimates, only the S—stationary and PB—partially blurred classifications are used in the blur mask since the distinction between blurred and non-blurred pixels are derivable from pixel profiles. Additional information such as motion estimates facilitates the distinction of B—blurred and PB—partially blurred pixel classifications for the purpose of object based motion blur restoration.

The areas of the image having common categories of pixels or pixel regions are groups into bounded regions, these bounded regions providing the blur mask of the meta-data. Thus, the blur mask 80 is used to indicate areas of an image in which motion resulted in blurring of the image. Post processing methods can use such masks to reduce, remove, or otherwise process the areas of the image defined by the mask. Detection of the blurred portions of the image may also be used for motion detection or object identification, such as in vision systems for intelligent systems, autonomous vehicles, security systems, or other applications where such information could be useful.

An important concept embodied in the foregoing discussion of the blur mask is that neighboring pixels or pixel regions experience the same or similar results during the imaging process. Blur does not occur in only a single pixel but instead is found over an area of the image. The detection of blur is assisted by computing a result for a neighborhood of pixels and the processing of the image to remove or otherwise treat the blur is carried out on the neighborhood of pixels. This neighborhood concept carries through to the following discussion of intensity masks and event time masks as well. Any distortion determined using the present invention may be recognized or processed by relying on neighboring pixels or pixel regions.

The detection of the blurring in the image requires sampling of the sensor during image acquisition. This may be performed in a number of ways, including sampling only selected ones of the pixels of the image or sampling all or most of the pixels in the sensor. To accomplish this, particularly the latter approach, requires a sensor or sensor array which permits non-destructive reading of the signal during the image acquisition. Examples of sensors that permit this are CMOS (Complementary Metal Oxide Semiconductor) sensors and CID (Charge Injection Device) sensors. The pixels or pixel groups can thus be looked at at multiple times during the image formation. In the case where non-destructive sensing is not possible, intra acquisition pixel values may be stored in external memory for processing.

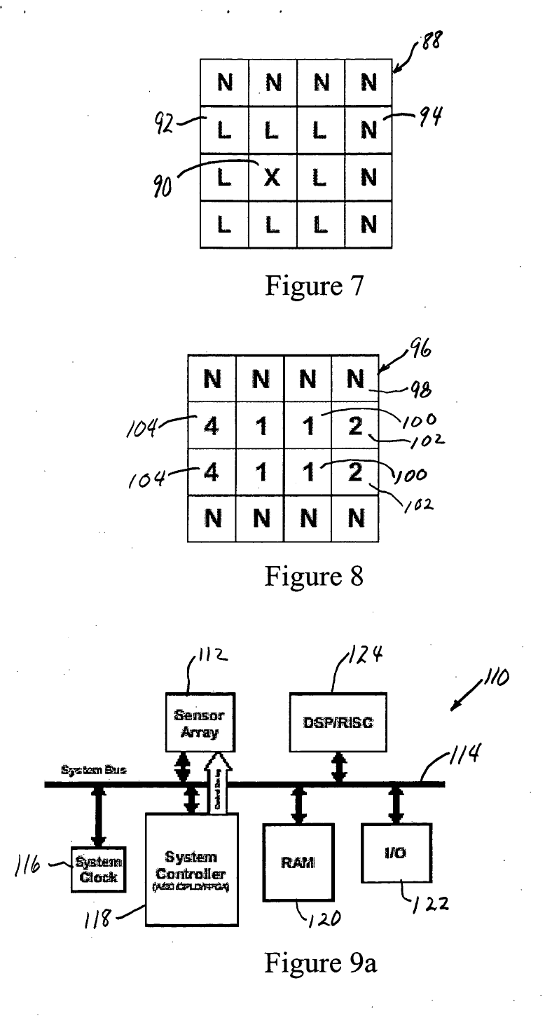

As shown in FIG. 7, an intensity mask 88 is provided in some embodiments of the invention. The intensity mask 88 provides meta-data that describes the relative reliability of a pixel or pixel region based on its intensity. There are two reasons to consider an intensity mask as an important element of the meta-data. First, in bright regions of the image, there is the possibility of saturated or nearly saturated pixels being present. Saturated pixels are no longer sensitive to further increases in image intensity during the image formation, therefore limiting the dynamic range of the pixel. Second, pixels that observe low light intensities are subject to significant uncertainty due to noise. The components of noise at a pixel may be signal independent or signal dependent. Signal independent noise may occur sporadically as for example read out noise or continuously as for example thermal or Johnson noise.

Signal dependent noise includes, for example, shot noise where the variance of this noise is typically proportional to the square root of signal intensity. In low lighting conditions, pixel responses to incident light can be dominated by both signal dependent and signal independent noise sources and should be processed according to this knowledge.

FIG. 7 illustrates the 4×4 intensity mask 88 that may correspond to a 4×4 group of pixels or a 4N×4M region of an image, where N×M is the size of image blocks over which the measurement was taken for each intensity mask element. The elements of the intensity mask 88 take one of three pixel states:

State X—Saturated: A pixel or pixel region receiving this designation has observed high intensity light based on the camera or imaging system settings, for example the intensity of the received light is too great for the length of the exposure. Pixels having this designation either have saturated or will saturate during the image exposure time. An example of state X is shown at 90.

State L—Low light: A pixel or pixel region assigned this designation has observed low light intensity relative to camera settings and may be underexposed. Consequently, a pixel or pixel region with the state L will be contaminated with noise. In other words, the noise will be a significant portion of the useful signal available from the pixel. An example of a pixel or pixel region with state L is at 92.

State N—Normal: A pixel or pixel region assigned this designation has been determined to have been properly exposed according to the camera settings and will need minimal noise processing. In other words, the noise signal is not a significant portion of the useful signal from this pixel or pixel region (because the useful signal is much higher than the noise portion of the signal) and the pixel has not reached or neared saturation. An example of a pixel or pixel region at state N is at 94.

The areas of the image having these states are grouped to form the bounded areas of the intensity mask. The intensity mask is a component of the meta-data according to embodiments of the invention.

The intensity mask 88 allows for powerful post-processing to localize computation efforts to remove distortions and extend camera performance. State L—low light pixels detected by this mask can be corrected by local filtering among other low light pixels or pixel regions. In other words, the noise signal is filtered out of the under-exposed, state L pixels or pixel regions. Bright state X—saturated class pixels that have not yet reached the saturation level may be extrapolated to their ultimate value with the assistance of an event time mask. The event time mask is discussed in greater detail hereinafter. It may also be possible to do an extrapolation of an ultimate value for pixels that have reached a saturation point. It may be necessary in such instances to perform a shifting of the brightness, or intensity, range of the image to accommodate the extrapolated value. This post-processing capability expands the linear dynamic range of the captured image for richer color and greater detail, or at least to obtain detail in an area of the image otherwise void of information (a region of saturated pixels).

The intensity mask 88 also allows for the detection of isolated false pixel values in an image. In general, the presence of low light and bright light pixels in isolation in the image are highly unlikely. In the image, the low light or bright light pixels correspond to objects in the image and are nearly always grouped with neighboring pixels having the same or similar light conditions. If saturated or low light pixels do occur in isolation, it is generally due to, for example, temporal noise, shot noise and/or fixed pattern noise as the source. These pixels are easily identified with an intensity mask such as shown in FIG. 7. For example, the saturated pixel 90 is surrounded by low light pixels 92, indicating that the saturation of the pixel 90 is most likely noise or other error in the pixel. Common post-processing techniques such as median filtering can be automatically applied locally to remove this and other distortions using the intensity mask.

As shown in FIG. 8, an event time mask 96 is provided in some embodiments of the invention. The event time mask 96 is used to provide a temporal marker that indicates when a distortion event is detected. The event time mask is an important class of meta-data that facilitates the correction of image distortions using post-processing software or hardware. As stated above, the I-Data, or intra-acquisition data, is obtained by sampling the sensor array during the image acquisition. The event time mask 96 can be expressed in terms of a sample number at which an event, which generally corresponds to a distortion event, was detected. In the illustration of FIG. 8, N samples are taken during the exposure and the pixels or pixel regions which have no detected events are marked by N at indicated at 98 to show that the last sample of the exposure was taken without recognition of an event.

FIG. 8 illustrates an event time mask for a 4×4 time event mask which may correspond to a 4×4 group of pixels or a 4N×4M region of an image where N×M is the size of image blocks over which the measurement was taken for each time event mask element. The temporal event mask can be used to indicate the start of a pixel blur, determine the support of a moving object, localize moving objects, determine the time at which a pixel saturated and thereby back project to the original pixel value based the exposure time. Alternative methods for accomplishing such results may be used as well. Multiple masks of each type may be generated to facilitate the correction of complex distortions. The usefulness of such masks can depend on the sophistication and available computing resources of the post-processing system.

In FIG. 8, the pixels or pixel regions 100 of the event time mask which are indicated as “1” identify a time event that occurred at a first sampling of the pixel or pixel region during the acquisition of the image. The pixels or pixel regions 102 which are labeled “2” denote an event sensed at the second sampling event. Pixels or pixel regions 104 that are denoted with “4” indicate that an event was sensed during the fourth sampling of the pixel or pixel region as the image was being obtained. The pixels or pixel regions marked N indicate that the full number of N samples has been performed during the acquisition of the image without detection of an event time. Here, the number N of samples being taken is greater than four. The number of samples N taken during the exposure of the image sensor varies and may depend on the exposure time, the maximum possible sampling frequency, the desired meta-data information, the capacity of the system to store event time samples, etc.

Pixel or pixel regions charge levels are determined at the various sampling times. This information may be used in post processing to reconstruct what a charge curve of a pixel or pixel region may have been without the distortion event, and thereby remove the distortion from the image. For example, movement of an object in the image frame during the image acquisition causes blurring in the image. The sampling may reveal portions of the exposure before or after the blurring effect and the sampled image signals are used to reconstruct the image without the blur. The same may apply for other events that occur during the image acquisition.

The event time mask may be used in the detection or correction of blur or over and under exposure in the image. In other words, the various masks of the meta-data are used together to the best advantage in the post processing of the image. In addition to the image features addressed in the foregoing, various other image characteristics and distortions may be determined by monitoring the timing of the events during the image acquisition. These additional characteristics and distortions are within the scope of this invention as well.

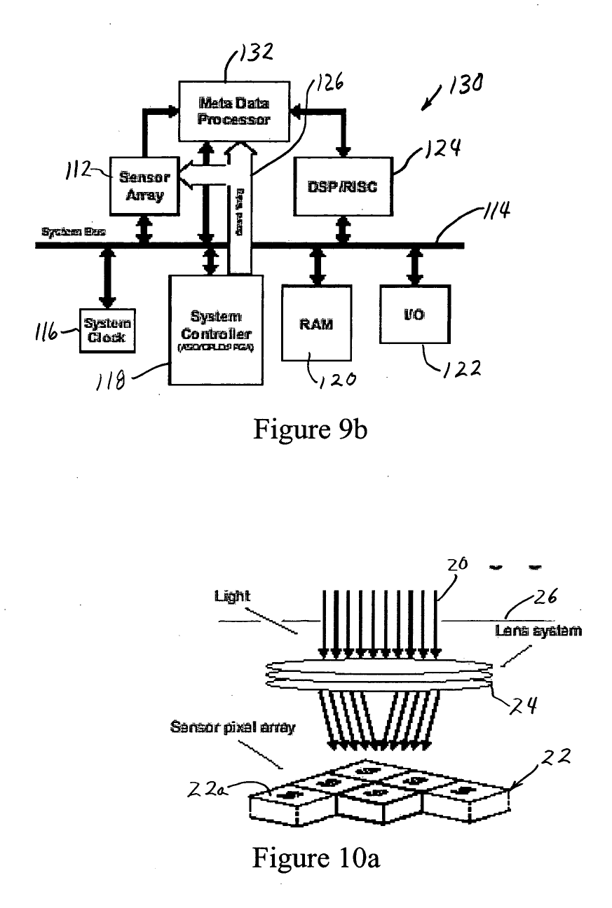

According to various embodiments of the invention, an imaging system is provided a meta-data processor. FIG. 9a illustrates a basic digital imaging system 110. The imaging system 110 includes a sensor array 112 (which may be the sensor array 22 of FIG. 8a) disposed to gather light focused through a lens arrangement (shown in FIG. 8a). The sensor array 112 is connected to a system bus 114 that in turn is connected to a system clock 116, a system controller 118, random access memory (RAM) 120, an input/output unit 122, and a DSP/RISC (Digital Signal Processor/Reduced Instruction Set Computer) 124. The system controller 118 may be an ASIC (Application-Specific Integrated Circuit), CPLD (Complex Programmable Logic Device), or FPGA (Field-Programmable Gate Array) and is connected directly to the sensor array 112 by a timing control 126.

FIG. 9b shows a digital imaging system 130 with the addition of a meta-data processor 132, wherein the same or similar elements are provided with identical reference characters. The meta-data processor 132 is connected directly to the sensor array 112 and to the DSP/RISC 124 and also receives the timing control signals over the connection 126. The meta-data processor 132 stores global P-Data (pre-acquisition data) and samples the image sensor 112 during image formation to extract and compute I-Data (intra-acquisition data) masks for use by an internal DSP/RISC (Digital Signal Processor/Reduced Instruction Set Computer) and/or external software for post processing. The meta-data processor 132 may be a separate programmable chip processor such as an application specific integrated circuit (ASIC), a field programmable gate array (FPGA) or a microprocessor.

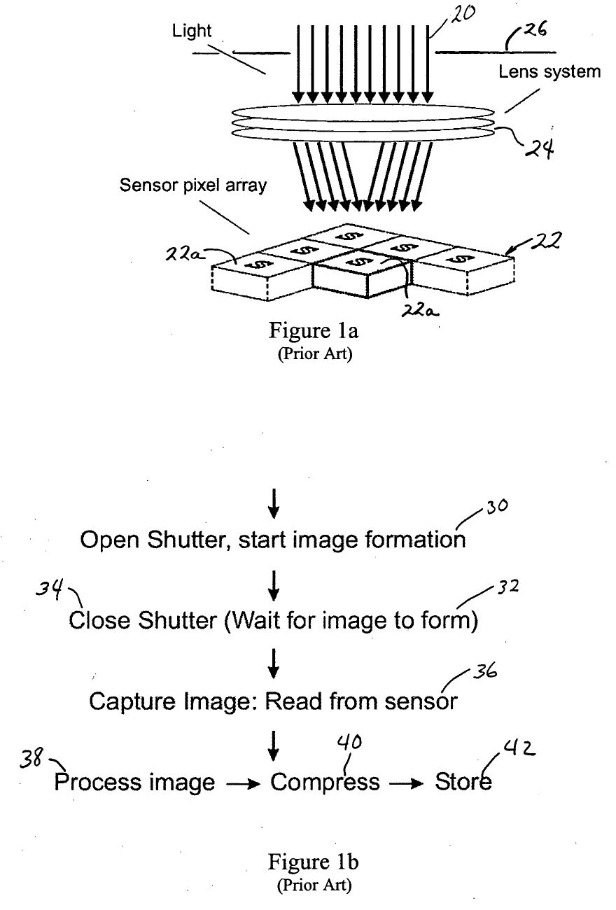

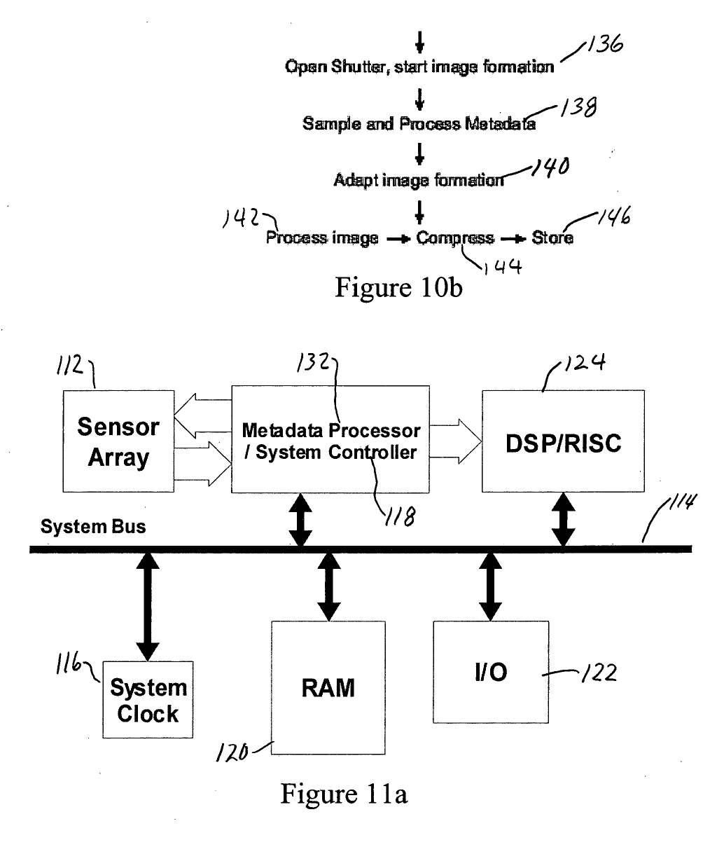

With reference to FIGS. 10a and 10b, the image acquisition is described. In FIG. 10a, just as in FIG. 1a, light 20 passes through a shutter and aperture 26, through a lens system 24 and impinges the sensor array 22, which is made up of pixels or pixel regions 22a. The functional activity of the meta-data processor during information is also illustrated in FIG. 10b. In particular, the steps include: open the shutter and start the image formation at 136, sample and process the meta-data at 138, adapt the image formation to the sampled meta-data 140 (an optional step available in some embodiments), process the image 142, compress the image 144 (also an optional step available in some embodiments), and store the image 146.

The sensor array 22 or 112 used in the present invention may be a black and white sensor array or a color sensor array. In color sensor arrays, it is common that pixel elements are provided with color filters, also known as a color filter array, to enable the sensing of the various colors of the image. The meta-data may apply to all the pixels or pixel regions of the senor array or may apply separately to pixels or pixel regions assigned to common colors in the color filter array. For example, all pixels of the blue filters in the filter array may have a meta-data component and pixels of the yellow filters have a different meta-data component, etc. The image sensing array may be sensitive to wavelengths other than visible light. For example, the sensor may be an infrared sensor. Other wavelengths are of course possible.

The sensor of the present invention may be a single chip or may be a collection of chips arranged in an array. Other sensor configurations are also possible and are included within the scope of this invention.

Meta-data extraction, computation and storage can be integrated with other components of the imaging system to reduce chip count and decrease manufacturing cost and power consumption.

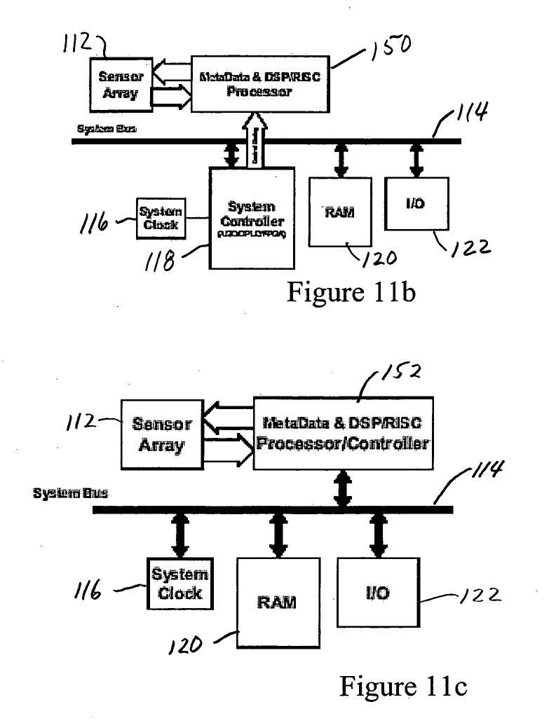

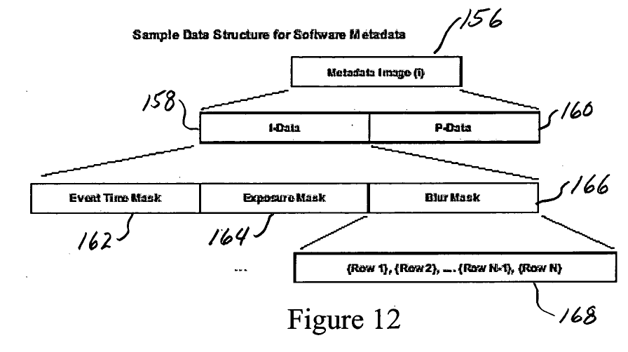

FIGS. 11a, 11b and 11c illustrate three additional configurations for meta-data processing incorporation into the imaging system. As above, the same or similar elements are provided with identical reference characters. In FIG. 11a, the meta-data processor 132 is combined with functions of the system controller. The sensor array 112 is only connected to the meta-data processor 132 so that all timing and control information flows therethrough.

FIG. 11b illustrates an embodiment in which a combination meta-data processor and DSP/RISC processor 150 is provided, thereby eliminating the separate DSP/RISC element. In FIG. 11c, a meta-data processing function is combined with system controller and DSP/RISC in single unit 152. The number of elements in the imaging system is thus dramatically reduced.

The meta-data is used by post image acquisition processing hardware and software. The meta-data developed according to the foregoing is output from the imaging system along with the image data, and may be included in the image data file, such as in header information, or as a separate data file. An example of the meta-data structure, whether it is to be separate or incorporated with image data, is shown in FIG. 12. In the data structure, a meta-data component for an image, whether it is a still image or video image, has the meta-data portion 156. Within the meta-data portion 156 is an I-Data portion 158 containing the intra-acquisition data and a P-Data portion 160, containing the pre-acquisition data. The I-Data portion is, in a preferred embodiment, made up of an event time mask 162, an exposure mask 164 and a blur mask 166. Each of the mask portions 162, 164 and 166 has a definition of the mask by row and column, such as shown at 168.

The example of the data structure of FIG. 12 permits the image information to be stored and read into and out of image processing and manipulation software. The information in the data structure may be entropy encoded (i.e., run length encoded) for efficient storage and transmission. This function is performed by the image sequence formatter.

The meta-data has been described as being extracted during the acquisition of the image data. The present invention also encompasses the extraction of the meta-data after the acquisition of the image data. For example, the data structure of FIG. 12, or another meta-data structure, may be generated or extracted after the image data has been acquired by the sensor and external to the camera using, for example, signal processing techniques of the acquired or observed scene. The meta-data can be generated in the camera or external to the camera; thus, the meta-data is not based on the camera being used.

Meta-data enabled software is preferably provided to process the image file provided with this additional information. The software of a preferred embodiment includes a graphical user interface (GUI) that runs on a personal computer or workstation under Windows, Linux or Mac OS. Other operating systems are of course possible. The software communicates with the imaging device via the camera's I/O (Input/Output) interface to receive the image data and meta-data. Alternatively, the software receives the stored data from a storage or memory. For example, the image may be stored to a solid state memory card and the memory card connected to the image processing computer through a appropriate slot in the computer or an external memory card reader. It is also within the scope of the present invention that the image data along with the meta-data is stored to magnetic tape, hard disk storage, or optical storage or other storage means. In a security system, for example, the image data is stored onto a mass storage system and only selected portions of the image data may be processed when needed.

The software for processing the image data displays the original degraded image and provides a window for viewing the post-processed scene. Alternately, the software may perform the necessary processing and show only the final, processed image. The software provides pull down menus and options to display post image acquisition processing processes and algorithms and their parameters. The user of the software is preferably guided through the image processing based on the information in the meta-data, or the processing may be performed automatically or semi-automatically. The software performs the meta-data enabled post-processing by accessing the I-Data and P-Data meta-data in the memory locations in the meta-data processor or memory via the I/O block. The I/O block can provide images and meta-data either via a wireless connection such as Bluetooth or 802.11 (A, B, or G) or via a wired connection such control timing

Control timing is possible using a parallel interface or serial interfaces such as USB I or II or Firewire. The meta-data aware post-processing software of a preferred embodiment provides an indication to the user that meta-data of a specific class is available to assist in post-processing. The GUI is capable of showing pixel regions that were found to be distorted according to the meta-data. These areas can be color coded to indicate to the user the type of distortion in a specific pixel region. The user can select pixel regions to enable or disable processing of a specific distortion. The user may also select a region for automatic or manual post processing.

Compression, enhancement or manipulation of the image data such as rotation, zoom, or scaling of the image sequence can be dictated by the downloaded meta-data. After the image or image sequence has been processed, the new image data may be saved via the software.

A method and apparatus for extracting and providing meta-data for the improved post-processing of digital images and video has thus been presented. The present improvements overcome the limitations in performance that most hardware and software based post-processing methods are subject to by the failure to account for or provide access to information regarding the scene, the distortion or the image formation process. An implementation of post-processing utilizing knowledge regarding scene, the distortion, or the image formation process is available by the present method and apparatus. The use of meta-data improves image and video processing performance including the compression, manipulation and automatic interpretation.

Although other modifications and changes may be suggested by those skilled in the art, it is the intention of the inventors to embody within the patent warranted hereon all changes and modifications as reasonably and properly come within the scope of their contribution to the art.

1. A method for image acquisition, comprising the steps of:
acquiring an image using a digital imaging system;
sensing a temporal change in an image at a pixel level or pixel region level while acquiring the image;
defining regions of the image at which said temporal change has been sensed during the image acquisition;
generating metadata corresponding to said defined regions; and
providing said metadata with image data when outputting the image data.

2. A method as claimed in claim 1, wherein said temporal change is a motion related change in at least a portion of the image.

3. A method as claimed in claim 2, wherein said motion related change is a result of motion of at least one object in the image while acquiring the image.

4. A method as claimed in claim 1, wherein said metadata is a mask corresponding to said defined regions.

5. A method as claimed in claim 4, wherein said mask is blur mask.

6. A method as claimed in claim 1, wherein said step of defining includes classifying pixels as stationary or blurred.

7. A method as claimed in claim 6, further comprising the step of:
defining ones of said pixels as partially blurred.

8. A method as claimed in claim 1, further comprising:
sampling at least ones of said pixels or said pixel regions during acquisition of image data for an image.

9. A method as claimed in claim 8, further comprising the step of:
determining a presence of a change in a rate of image signal accumulation at pixels or pixel regions during the acquisition of the image, said change indicating motion during the acquisition of the image.

10. A method as claimed in claim 8, wherein said sampling is performed a plurality of times during the acquisition of the image.

11. A method as claimed in claim 10, further comprising the step of:
generating a event time mask identifying times during the image acquisition at which an event occurred in the signal accumulation as detected by said sampling.

12. A method as claimed in claim 11, wherein said times are identified by sample sequence number.

13. A method as claimed in claim 1, further comprising the step of:
identifying pixels or pixel regions receiving a signal intensity below a predetermined low signal threshold during the image acquisition.

14. A method as claimed in claim 1, further comprising the step of:
identifying pixels or pixel regions receiving a signal intensity above a predetermined high signal threshold during the image acquisition.

15. A method as claimed in claim 14, further comprising the step of:
generating an exposure mask of areas having pixels or pixel regions above said predetermined high signal threshold.

16. A method as claimed in claim 14, further comprising the step of:
identifying pixels or pixel regions receiving a signal intensity below a predetermined low signal threshold during the image acquisition.

17. A method as claimed in claim 16, further comprising the step of:
generating an exposure mask of areas having pixels or pixel regions above said predetermined high signal threshold and of areas having pixels or pixel regions below said predetermined low signal threshold.

18. A method as claimed in claim 16, further comprising the step of:
generating a event time mask identifying times during the image acquisition at which an event occurred in the signal accumulation as detected by said sampling.

19. A method as claimed in claim 18, further comprising the step of:
outputting said event time mask and said exposure mask and said blur mask as meta-data accompanying image data obtained during the image acquisition.

20. A method as claimed in claim 14, wherein said predetermined high signal threshold is near or at a saturation level for the pixel or pixel region.

21. A method for image acquisition, comprising the steps of:
acquiring an image using a digital imaging system;
sampling pixels during said step of acquiring the image;
determining a change in intensity build up in pixels during said step of acquiring the image;
defining regions of the image which have a change of intensity build up of greater than a predetermined threshold; and
including information on said regions with data of the image.

22. A method as claimed in claim 21, wherein said information on said regions is mask information.

23. A method as claimed in claim 21, wherein said change in intensity corresponds to motion of at least one object whose image is being acquired during the acquiring of the image.

24. A method as claimed in claim 21, wherein said change in intensity corresponds to saturation of at least one pixel.

25. A method for image acquisition, comprising the steps of:
acquiring an image using a digital imaging system;
sensing pixels at or near saturation during said acquiring of the image;
sensing pixels below a predetermined threshold of light intensity;
defining regions of the image with pixels at or near saturation and regions below said predetermined threshold;
including information on said regions with data of the image.

26. An apparatus for image acquisition, comprising:
an optical system for focusing an image on a sensing chip;
a sensing chip positioned to receive said image from said optical system;
a processor connected to said sensing chip for two way communication with said sensing chip, said processor generating meta-data regarding regions of the image corresponding to predetermined conditions, said processor including said meta-data with data of said image upon output of the image.

27. An apparatus as claimed in claim 23, wherein said meta-data includes at least one of an event time mask and an exposure mask and a blur mask.
